(19) United States
(12) Patent Application Publication
(10) Pub. No.: US 2026/0351897 A1
(43) Pub. Date: Nov. 5, 2026

(54) Securing Element for Mechanically Securing a Housing Latch of a Plug-in Connection, Plug-in Connector Housing Arrangement, and Plug-in Connection

(71) Applicant: ROSENBERGER HOCHFREQUENZTECHNIK GMBH & CO. KG, Fridolfing (DE)

(72) Inventor: Manuel Pemwieser, Tittmoning (DE)

(21) Appl. No.: 19/645,749

(22) Filed: Apr. 13, 2026

(30) Foreign Application Priority Data
Apr. 16, 2025 (EP) 25170877.2

(51) Int. Cl. H01R 13/627; H01R 13/502; H01R 13/629

(52) U.S. Cl. CPC H01R 13/6275; H01R 13/502; H01R 13/62933

(57) ABSTRACT

A securing element for mechanically securing a housing latch of a plug-in connection. The securing element has at least one connecting means for the exclusively rotatable and direct connection to a plug-in connector housing of a plug-in connector of the plug-in connection, which, together with a mating connecting means of the plug-in connector housing, can form a rotary joint, which has a rotational axis (D) for said rotatable connection. The securing element also has at least one securing means which is connected to the connecting means), the securing means being spaced apart from the rotational axis (D), such that the securing means, during a rotation of the securing element around the rotational axis (D) along a circular path (K), can be moved, starting from a release position, into a securing position, in which the securing means can secure the housing latch of the plug-in connection.

### BACKGROUND

The invention relates to a securing element for mechanically securing a housing latch of a plug-in connection, comprising at least one connecting means for connecting to a plug-in connector housing of a plug-in connector of the plug-in connection, and at least one securing means which is movable starting from a release position into a securing position and is able to secure the housing latch of the plug-in connection.

The invention further relates to a plug-in connector housing arrangement for a plug-in connector, comprising said securing element and the plug-in connector housing.

The invention also relates to a plug-in connection, comprising a plug-in connector having a plug-in connector housing arrangement, and a mating plug-in connector having a mating plug-in connector housing.

Various electrical and optical plug-in connectors are known from connection technology. Plug-in connectors serve, as is known, for transmitting data signals and/or electrical power to corresponding mating plug-in connectors. A plug-in connector or mating plug-in connector can be, inter alia, a plug, a printed circuit board connector, a panel connector, a socket, a coupling or an adapter. The term “plug-in connector” or “mating plug-in connector” used within the context of the invention is representative of all variants.

In order to ensure the correct latching between the plug-in connector housing and the mating plug-in connector housing in the event of a mated plug-in connection, housing securing elements are often used, which are known, inter alia, as “Connector Position Assurance” (CPA). Such securing elements serve firstly to ensure that a complete and correct connection has been established between the plug-in connector and the mating plug-in connector, and secondly also prevent unintentional release of the (primary) housing latch between the housings of the connection partners.

Known CPAs are usually designed for this purpose as additional elements which can be moved along the longitudinal axis or along the plug-in direction of the plug-in connector. Moving the CPA starting from a release position into a securing position ultimately secures the housing latch and ensures that the plug-in connection has been properly established. It is customary here for the CPA to be guided in a translational manner through a pin-slot guide or other linear guide in the plug-in connector housing and to have an actuating surface for the installer at the cable-side end.

One disadvantage of the known CPAs is that they naturally require a comparatively large amount of installation space in the longitudinal or plug-in direction of the plug-in connector. This is contrary to the frequently applicable miniaturization requirements and is problematic, in particular, in the case of plug-in angle connectors, in which the available installation space is structurally limited in the axial direction. In such cases, the integration of a conventional CPA can either not take place or leads to a disproportionate increase in the installation space requirement, which limits the usability of a CPA in compact assemblies or confined installation conditions.

In view of the known state of the art, the object of the present invention consists in providing a securing element for securing a housing latch of a plug-in connection, in which the required installation space, in particular in the longitudinal or plug-in direction of the plug-in connector housing, is small.

The present invention is also based on the object of providing a plug-in connector housing arrangement, which has a securing element for securing a housing latch of a plug-in connection, in which the required installation space, in particular in the longitudinal or plug-in direction of the plug-in connector housing, is small.

Finally, it is also an object of the invention to provide a plug-in connection which comprises a securing element for securing a housing latch between a plug-in connector and a mating plug-in connector, in which the required installation space, in particular in the longitudinal or plug-in direction of the plug-in connector housing, is small.

### SUMMARY OF THE INVENTION

The object is achieved for the securing element by way of the features presented herein. In respect of the plug-in connector housing arrangement and with respect to the plug-in connection, the objects are also achieved by the features presented herein.

The features described below relate to advantageous embodiments and variants of the invention.

The invention relates to a securing element for mechanically securing a housing latch of a plug-in connection.

The “securing element” within the context of the present invention can be, in particular, a CPA already mentioned above, that is to say a securing element having one, more than one or all of the technical features and functions normally known to the skilled person with regard to CPAs. However, the invention is not necessarily to be understood as restricted to equating the terms “securing element” and “CPA”, since the securing element can, for example, also have features which differ from a CPA and may not necessarily include all the features of a CPA either. The invention thus covers any securing elements which can be suitable for mechanically securing a housing latch of a plug-in connection.

The securing element is preferably not used to secure contact elements in the plug-in connector housing and preferably also not to engage or secure a latch between contact elements and mating contact elements of the plug-in connection.

Preferably, the securing element is provided for direct mechanical securing of the housing latch. The securing element thus preferably directly contacts or blocks at least one component participating in the housing latch or a component participating in the housing latch of the plug-in connector or the mating plug-in connector (for example, the “latching means” or “mating latching means” mentioned below). In principle, however, the securing element can also serve for indirect securing of the housing latch (for example, by directly securing an intermediate element which is arranged between the securing element and one of the components of the housing latch).

Within the context of the invention, a “housing latch” means, in particular, a primary housing latch or a so-called “primary latch” between a plug-in connector housing and a mating plug-in connector housing. In particular, the housing latch may be a direct latch between the plug-in connector housing or a plug-in connector housing component and the mating plug-in connector housing or a mating plug-in connector housing component. The housing latch to be secured can in particular be a non-destructively detachable latch and/or lock. In principle, however, a housing latch which can no longer be detached non-destructively after latching can also be additionally secured by the proposed securing element.

Preferably, the securing element is not to be understood as part of the actual housing latch, but rather as an additional component.

The securing element or the invention can preferably be suitable for use with an electrical or optical plug-in connection. Insofar as the invention is described below substantially on the basis of an electrical plug-in connection, this is not to be understood as limiting.

According to the invention, the securing element has at least one connecting means for the exclusively rotatable and direct connection to a plug-in connector housing of a plug-in connector of the plug-in connection. The connecting means of the securing element together with a mating connecting means of the plug-in connector housing can form a rotary joint, which has a rotational axis for said rotatable connection.

The securing element is preferably a one-piece or one-part component. Therefore, the at least one “connecting means” can be, in particular, a region or portion of the (one-part) securing element. This can apply mutatis mutandis to all components of the securing element which are mentioned below, such as for example the at least one “securing means” and the at least one “actuating means” mentioned below. In principle, however, it can also be provided (less preferably) that the securing element is formed in multiple parts, which is why one or more of the means mentioned above and below can also be understood as individual components of the securing element.

The securing element can preferably have exactly one connecting means or exactly two connecting means. In principle, any desired number of connecting means can be provided for the exclusively rotatable and direct connection to the plug-in connector housing. Insofar as a plurality of connecting means are provided (i.e., for example, two connecting means), they are preferably arranged aligned with each other in such a way that the rotational axes of the respective rotary joints coincide or lie on top of each other.

According to the invention, the securing element additionally has at least one securing means, which is connected to the connecting means (preferably directly or in one piece, but also optionally only indirectly or via at least one additional component or means). The securing means is spaced apart from the rotational axis, such that the securing means, during a rotation of the securing element around the rotational axis along a circular path, can be moved, starting from a release position (in which the securing means does not yet secure the housing latch of the plug-in connection), into a securing position, in which the securing means can secure the housing latch of the plug-in connection.

In principle, any desired number of securing means can be provided, wherein preferably exactly one securing means or exactly two securing means are present. Insofar as a plurality of securing means are provided, they are preferably arranged immovably with respect to each other or positioned fixedly relative to each other, such that the securing means can be moved together along a respective circular path during a rotation of the securing element. Moreover, the number of securing means does not necessarily have to correspond to the number of connecting means, which is why, for example, only exactly one securing means can also be provided, which is connected together with two connecting means.

Preferably, it can be provided that the securing means has a securing surface, which preferably has a direction component in an at least substantially tangential direction or plug-in direction (“tangential” with respect to the circular path running around the rotational axis)—at least when the securing means is in the securing position. Preferably, the securing surface can also have a second direction component which runs at least substantially in the lateral direction with respect to a longitudinal or central axis of the plug-in connector, or which runs at least substantially in the radial direction with respect to the rotational axis of the securing element.

The required installation space, in particular in the longitudinal or plug-in direction or in the plug-in direction of the plug-in connector, can be significantly reduced compared to a conventional CPA with a linear displacement path in that the proposed securing element is formed in such a way that the at least one securing means can be transferred into the securing position by an exclusively rotatable (circular) movement. The proposed securing element is therefore ideally suited, inter alia, for applications with limited axial installation space, as is the case, for example, in plug-in angle connectors. Compared to the conventional CPAs, the proposed securing element offers design freedom for designing significantly more compact plug-in connections.

The fact that an exclusive rotational movement of the securing element is provided in the context of the invention means that complex guide mechanisms, such as rail guides or slotted guides, can be dispensed with. In contrast, the implementation of the aforementioned rotary joint can be carried out by way of technically simple measures, which can sometimes lead to improved manufacturing, assembly and operating capability and thus, not least, to plug-in connectors which can be manufactured particularly economically. The rotary joint can also provide a captive securing means for the securing element, such that the securing element (in particular, in the release position) cannot be unintentionally disconnected from the plug-in connector housing.

The securing element is advantageously suitable for manual as well as for (partially) automated assembly processes (it can therefore be actuable manually with a tool or without tools by a fitter and/or by an assembly device or—in special cases—by a component of the mating plug-in connector). Due to the lever arm resulting by spacing the securing means apart from the rotational axis, the securing element can sometimes also be actuated by an effort which is low or at least predeterminable in a targeted manner in advance.

In one advantageous development of the invention, it can be provided that the securing element has at least one connecting leg to connect the at least one connecting means to the at least one securing means.

By using corresponding connecting legs, the radius of the circular path, along which the securing means is moved during a rotation of the securing element around the rotational axis, the required actuating force (by the resulting mechanical lever) and the length of the possible displacement path (i.e. the distance between the release position and the securing position) can be adjustable. A person skilled in the art is able to position the connecting means and the securing means on the connecting leg accordingly relative to each other depending on the application.

It can be provided that the securing element has exactly one connecting leg. Preferably, however, a plurality of, in particular (but not exclusively) two, connecting legs lying opposite each other are provided. Insofar as a plurality of connecting legs are provided, they can preferably be arranged with respect to each other in such a way that the rotational axes of all resulting rotary joints lie on top of each other. Thus, a plurality of connecting legs can therefore preferably be arranged with respect to each other in such a way that connecting means in each case arranged on the connecting legs are aligned with each other with respect to the rotational axis.

In so far as a plurality of connecting legs are provided, in particular if two connecting legs are provided, they can be connected to each other via a common connecting web (one-piece or monolithic or multi-part).

The at least one connecting leg can preferably be an elongate component extending from a first end to a second end, and thus having at least a first end portion, a middle portion and a second end portion.

In one preferred embodiment of the invention, it can be provided that the at least one connecting means is formed on a first end portion of the connecting leg. However, it should be mentioned that this is not absolutely necessary. This is because the at least one connecting means can be arranged in principle at any point of the connecting leg, that is to say, for example, also in a middle portion along a longitudinal extent of the connecting leg.

In one variant of the invention, it can be provided that the at least one securing means is arranged or formed on a second end portion of the connecting leg, which can be arranged so as to lie opposite the abovementioned first end portion (but, if necessary, independently of whether the at least one connecting means is arranged on the first end portion or at another location along the connecting leg). If there are connecting means and securing means on opposite end portions of the connecting leg, the lever arm of the connecting leg can be used particularly satisfactorily. Insofar as exactly two connecting legs are provided, this variant is particularly advantageously suitable, even if two securing means are provided (and thus one on each connecting leg). However, it should be emphasized that the at least one securing means can be arranged in principle at any desired point of the connecting leg, that is to say, for example, even in the middle portion already mentioned.

In one variant of the invention, it can also be provided that the at least one securing means is formed or arranged on the connecting web, which connects a plurality of connecting legs to each other, and/or is formed or arranged on an elevation connected to the connecting leg or to the connecting web, for example on a connecting arm, on a connecting web or on a projection. In this way too, the lever arm of the connecting leg can be used very satisfactorily. This variant of the invention is particularly advantageously suitable if exactly one securing means is provided, in particular if this is arranged centrally or in the middle between the connecting legs.

In one advantageous development of the invention, it can be provided that the connecting means has a hole for receiving a pin of the plug-in connector housing or a pin for receiving in a hole of the plug-in connector housing.

This hole may be, inter alia, a through bore, a stepped bore or a blind bore. The bore preferably has a circular cross section, wherein the bore is preferably not formed as a slotted hole, since, within the context of the invention, an exclusive rotation is advantageously to be made possible. In principle, any desired recess can be provided for receiving said pin or a comparable elevation, that is to say, for example, also a recess having a rectangular or other cross section.

Preferably, the pin can have a round cross section. In principle, however, the cross section of the pin can also be as desired (e.g. rectangular).

As already mentioned, as an alternative to a pin, any desired elevation can be provided, which can be accommodated in any desired recess in order to form a (exclusively rotatable) rotary joint.

According to one development of the invention, it can be provided that the securing element additionally has an actuating means, by means of which, for example, a user or fitter or an assembly device can initiate the rotation of the securing element around the rotational axis in order to move the securing means along the circular path between the release position and the securing position.

The actuating means is preferably an actuating surface which is spaced apart from the rotational axis, is particularly preferably actuable manually by a technician and is therefore correspondingly accessible from outside the plug-in connector housing.

The actuating means can preferably be formed on the second end portion of the abovementioned at least one connecting leg or at a position spaced apart from the connecting means or rotary joint along the at least one connecting leg. In the case of a plurality of connecting legs, the actuating means can preferably be formed on the connecting web which connects the plurality of connecting legs to each other.

The actuating means can be arranged, in particular, on a side of the connecting leg which faces away from the securing means.

According to one development of the invention, it can be provided that an actuating direction for the actuating means is not directed toward the connecting means. In particular, it can be provided that the actuating direction runs at least substantially in a tangential direction with respect to the circular path, along which the securing means is movable.

It can be provided that the actuating direction for the actuating means is oriented at least substantially orthogonally with respect to an imaginary straight line which runs between the actuating means and the connecting means.

In one advantageous embodiment of the invention, it can be provided that the securing element additionally has a further or a second actuating means to move the securing means along the circular path from the securing position back into the release position. In the case of an actuation of the second actuating means, the rotation of the securing element can therefore preferably take place in a further or second actuating direction, which is directed counter to the first actuating direction mentioned above within the context of the first actuating means.

In one development of the invention, it can be provided that the securing element additionally has at least one locking means, which is connected to the connecting means and is designed to block a rotation of the securing element by interaction with the plug-in connector housing, when the securing means is in the release position, and to only release it as a result of a plug-in operation with the mating plug-in connector.

The locking means can preferably (but not necessarily) be spaced apart from the rotational axis.

Said securing means can thus advantageously form an actuation prevention means for the securing element, such that the securing element can only be actuated when the plug-in connector or the plug-in connector housing is correctly connected to the mating plug-in connector or the mating plug-in connector housing. Firstly, it can be ensured that the securing element is not inadvertently moved into the securing position and, secondly, the movability of the securing element can show the installer or an assembly device that the previous plug-in operation has been carried out correctly and completely.

It can preferably be provided that the locking means has a longitudinal extent, which extends at least substantially in the plug-in direction, in particular when the securing element is in the securing position or in the release position. In addition or alternatively, it can be provided that a longitudinal extent of the locking means runs at least substantially in a tangential direction relative to the circular path of the rotational movement of the securing means.

In principle, the locking means can be positionable in the securing element in a manner comparable to the securing means, which is why the features and advantages mentioned above with regard to the arrangement of the securing means (for example, the arrangement on an end portion of the connecting leg, on a connecting web connecting a plurality of connecting legs, or on an elevation connected to the connecting leg or the connecting web) can also apply to the locking means.

In one embodiment of the invention, it can also be provided, in particular, that the locking means has the securing means—or vice versa, wherein securing means and locking means can also possibly be identical. The locking means can, for example, be formed or arranged on a front, free end portion of an elongate securing means (e.g. as a connecting arm, connecting web or projection).

The invention also relates to a plug-in connector housing arrangement for a plug-in connector, comprising a securing element according to the embodiments above and below and the plug-in connector housing, wherein the connecting means of the securing element with the mating connecting means of the plug-in connector housing forms the rotary joint and is exclusively rotatable and directly connected to the plug-in connector housing.

Advantageously, a securing element, in particular a securing element formed as a CPA, can be provided for a plug-in connector, which is rotationally or arcuately movable, in contrast to a translational movement which is routine in the prior art. In this way, the plug-in connector housing can be realized in a much shorter design. It is a further advantage of the invention that the securing element has to protrude significantly less from the plug-in connector housing in the release position, which means that it can be protected in an improved manner against mechanical damage. Complex linear guides, such as guide rails or slotted guides, can be advantageously dispensed with in the plug-in connector housing.

The plug-in connector can preferably be an electrical or optical plug-in connector, as already mentioned above.

The plug-in connector housing of the plug-in connector can be formed in one or more parts, for example from a plastic and/or from a metal. As mentioned above, the securing element is preferably a separate component from the plug-in connector housing. In one less preferred variant of the invention, the securing element can optionally also be formed in a single-piece or monolithic manner with the plug-in connector housing, for example when the rotary joint is formed as a solid body joint or integral hinge.

In one development of the invention, it can be provided that the plug-in connector housing arrangement has a latching means which is connected to the plug-in connector housing and, together with a corresponding mating latching means of the mating plug-in connector, can form the housing latch of the plug-in connection.

The latching means for forming the housing latch can preferably be formed in a single-piece or monolithic manner with the plug-in connector housing. In principle, however, the latching means can also be formed in multiple parts with the plug-in connector housing, i.e. as a separate component, for example.

The latching means or the mating latching means can be arranged in a translationally and/or rotationally movable manner, wherein the respective other connection partner (latching means or mating latching means) is preferably of fixed or rigid formation. Preferably, one of the connection partners is thus elastically deflectable and/or movably mounted.

Corresponding latching means and mating latching means for the formation of a (primary) housing latch are generally sufficiently known.

In one preferred development of the invention, it can be provided, in particular, that the latching means of the plug-in connector housing is formed as an elastic latching hook or as an elastic latching rocker.

Alternatively, the mating latching means of the mating plug-in connector housing can be formed as an elastic mating latching hook or as an elastic mating latching rocker. The features described here with regard to the housing latch can always be exchanged or distributed as required between the plug-in connector and the mating plug-in connector.

It can preferably be provided that the securing element is a component independent of the latching means of the plug-in connector housing and thus of the housing latch. Thus, a movement or deflection of the latching means can preferably not also lead to a movement or deflection of the securing means—and preferably also vice versa.

It can preferably be provided that the securing element is connected via the at least one connecting means to a mechanically immovable or rigid portion of the plug-in connector housing. For example, the securing element is therefore preferably not arranged at or on the latching means of the housing latch.

It can be provided that the at least one securing means of the securing element engages behind at least one component of the housing latch, that is to say, for example, the abovementioned latching hook or the latching rocker, in the securing position, starting from the inner side of the plug-in connector housing, in order to physically block unlocking of the housing latch. Alternatively, however, it can also be provided that the at least one securing means of the securing element mechanically interacts from outside the plug-in connector housing with the housing latch, that is to say, for example, with the latching hook or the elastic latching rocker, in order to prevent unlocking.

In one advantageous development of the invention, it can be provided that the securing element bears against a first stop of the plug-in connector housing in the release position of the securing means, and/or that the securing element bears against a second stop of the plug-in connector housing in the securing position of the securing means.

The movement of the securing element can therefore be limited between the release position and the securing position. In this way, it can be ensured, in particular, that, in the release position, the securing element does not inadvertently assume an unfavorable starting position for assembly.

In principle, any desired first and/or second stops in the plug-in connector housing can be considered, which preferably correspondingly interact directly with the securing element or one of the components or one of the means of the securing element.

For example, the stops can be formed as projections or recesses, steps, webs, ribs, pins, bolts, notches, etc. A stop is therefore not necessarily to be understood only as a stop surface, since a “stop” can also be realized within the scope of the invention, in particular, by a linear or punctiform stop.

In one development of the invention, it can be provided that the first stop interacts with a first portion of the securing element which is adjacent to the first stop in such a way that the securing element in the release position is in a first angular position, and that the second stop interacts with a second portion of the securing element which is adjacent to the second stop in such a way that the securing element in the securing position is in a second angular position different than the first angular position.

It can be provided, for example, that the first stop and/or a first portion of the securing element adjacent to the first stop defines a first stop plane, which is oriented at an angle with respect to a second stop plane, which is defined by the second stop and/or a second portion of the securing element which bears against the second stop.

It can be provided, in particular, that the first stop and the second stop of the plug-in connector housing are formed on different side surfaces of the plug-in connector housing, and/or that the portions of the securing element provided for bearing against the stops are formed on different side surfaces of the securing element. These can preferably be side surfaces directly adjacent with respect to each other—as opposed to side surfaces which lie opposite each other.

It can be provided that, in the respective “abutted state” (when a portion of the securing element bears against one of the stops), the reaction force, which would act on the securing element in the case of a further movement in the direction of the respective stop, is oriented at an angle with respect to the corresponding reaction force on the other stop, in contrast to a parallel/anti-parallel orientation. Preferably, an orientation angle between said reaction forces of between 0° and 180° is provided, in particular an orientation angle of between 30° and 150°, particularly preferably an orientation angle of between 45° and 135°, particularly preferably an orientation angle of between 60° and 120°, very particularly preferably an orientation angle of at least substantially 90°.

In one advantageous development of the invention, it can be provided that the first stop and/or the second stop are/is formed in the rotary joint or directly adjacently with respect to the rotary joint.

For example, a pin of the rotary joint may have one or more webs, tabs or the like, which are capable of coming into contact with corresponding elevations, which are arranged around a bore of the rotary joint, in which the pin is received, in defined angular portions. Alternatively, it can also be provided in a complementary manner that a bore of the rotary joint has one or more inner-casing-side webs, tabs or the like, which are movable in corresponding grooves or other recesses in the corresponding pin.

As has already been mentioned above, the invention is suitable in principle for use with plug-in connectors or for plug-in connector housings of any desired design. In one preferred development of the invention, however, it can be provided that the plug-in connector housing is designed as a plug-in angle connector housing, since the advantages according to the invention become particularly clear in this case. In principle, however, elongate or straight plug-in connectors can also be provided.

In one embodiment of the invention, it can be provided that the securing element and the plug-in connector housing form a first latching connection in the release position of the securing element and/or a second latching connection in the securing position of the securing element. Accordingly, the plug-in connector housing and/or the securing element can have correspondingly suitable latching elements, such as latching hooks or latching depressions or other suitable means for establishing the first and/or second latching connection.

The invention also relates to a plug-in connector, in particular an electrical or optical plug-in connector, having a plug-in connector housing arrangement according to the embodiments above and below.

In addition to the plug-in connector housing arrangement, the plug-in connector can comprise any desired further plug-in connector components, such as an outer conductor contact element, one or more internal conductor contact elements running in the outer conductor contact element, dielectric or electrically insulating components, sealing elements and components for absorbing the cable tension. The type of plug-in connector and the plug-in connector components that are specifically used do not necessarily matter in the context of the present invention.

The invention also relates to a plug-in connection, in particular an electrical or optical plug-in connection, comprising a plug-in connector having a plug-in connector housing arrangement according to the embodiments above and below, and a mating plug-in connector having a mating plug-in connector housing, wherein the plug-in connector housing is mechanically connected to the mating plug-in connector housing and said connection is latched via the mutual housing latch and additionally secured via the securing element by securing the housing latch.

Advantageously, it can be provided that the at least one securing means of the securing element blocks the movability of the housing latch, in particular the deflection or actuation capability of a corresponding latching means of the plug-in connector housing, in at least one spatial direction in the securing state. The securing means can thus advantageously prevent the housing latch of the plug-in connection from being unintentionally released. For example, the abovementioned latching rocker or a latching hook can therefore be prevented from stretching, such that a mating latching element of the mating plug-in connector housing latched by way of latching rocker or latching hook cannot be released from the latching connection.

Preferably, in the release position, the securing element is positioned in the plug-in connector housing in such a way that the movement of the securing element into the securing position is initially blocked and is only releasable by a plug-in operation of the plug-in connector housing with the mating plug-in connector housing (preferably by direct actuation of the abovementioned “locking means” of the securing element by the mating plug-in connector housing during the plug-in operation).

In one development of the invention, it can be provided that the securing means of the securing element, preferably the entire securing element, is not directly mechanically connected to the mating plug-in connector housing.

Preferably, the securing element thus secures exclusively the housing latch and in this respect, particularly preferably, exclusively the corresponding latching means of the plug-in connector housing and/or the mating latching means of the mating plug-in connector housing. The securing element is therefore preferably not a secondary or redundant housing latch, but rather a securing means of a housing securing means which can fundamentally be used functionally even without the securing element.

Features which have been described in conjunction with one of the subjects of the invention, these being specifically the securing element according to the invention, the plug-in connector housing arrangement, the plug-in connector, the mating plug-in connector, the mating plug-in connector housing arrangement and the plug-in connection, can also advantageously be implemented for the other subjects of the invention. Likewise, advantages specified in conjunction with one of the subjects of the invention can also be understood in relation to the other subjects of the invention.

In addition, it should be noted that terms such as “comprising”, “having” or “with” do not exclude other features or steps. Furthermore, terms such as “a/an” or “the” indicating steps or features in the singular do not exclude a plurality of features or steps—and vice versa.

It should be mentioned that designations such as “first” or “second”, etc. are used predominantly for reasons of distinguishability between respective device or method features, and are not necessarily intended to indicate that features are mutually dependent or related to one another.

Furthermore, it should be emphasized that the values and parameters described in the present case also encompass deviations or fluctuations of ±10% or less, preferably ±5% or less, more preferably ±1% or less, and very particularly preferably ±0.1% or less, of the respectively stated value or parameter, provided that these deviations are not excluded in practice when implementing the invention. The specification of ranges by way of start and end values also encompasses all values and fractions encompassed by the respectively stated range, in particular the start and end values and a respective mean value.

Exemplary embodiments of the invention will be described in greater detail below with reference to the drawings.

### DRAWINGS

The figures each show preferred exemplary embodiments, in which individual features of the present invention are illustrated in combination with one another. Features of one exemplary embodiment can also be implemented separately from the other features of the same exemplary embodiment, and can accordingly be readily combined with features of other exemplary embodiments by a person skilled in the art to form further useful combinations and sub-combinations.

In the figures, functionally identical elements are provided with the same reference signs.

In the figures, in each case schematically:

FIG. 1 shows an electrical plug-in angle connector having a plug-in connector housing arrangement with a securing element according to a first exemplary embodiment of the invention, in a perspective illustration,

FIG. 2 shows the securing element of the first exemplary embodiment, in a perspective individual illustration,

FIG. 3 shows the electrical plug-in angle connector according to FIG. 1 in a lateral sectional illustration according to the sectional plane A-A in FIG. 7, in an unplugged state with the corresponding mating plug-in connector,

FIG. 4 shows a plugged plug-in connection comprising the electrical plug-in angle connector according to FIG. 3 and a corresponding mating plug-in connector, in a lateral sectional illustration according to the sectional plane A-A in FIG. 7, wherein a locking means of the securing element of the mating plug-in connector housing has been unlocked in order to release the securing element for a movement into the securing position,

FIG. 5 shows the plugged plug-in connection according to FIG. 4, in a lateral sectional illustration according to the sectional plane A-A in FIG. 7, wherein the securing element has been moved, starting from the release position in FIG. 4, into a securing position, in which the housing latch is secured by the securing element,

FIG. 6 shows the plugged plug-in connection according to FIG. 5 in a lateral sectional illustration according to the sectional plane B-B in FIG. 7,

FIG. 7 shows a sectioned plan view of the plugged plug-in connection according to FIG. 5,

FIG. 8 shows an electrical plug-in angle connector having a plug-in connector housing arrangement with a securing element according to a second exemplary embodiment of the invention, in a perspective illustration,

FIG. 9 shows the securing element of the second exemplary embodiment, in a perspective individual illustration,

FIG. 10 shows the electrical plug-in angle connector according to FIG. 8 in a lateral sectional illustration, in an unplugged state with the corresponding mating plug-in connector,

FIG. 11 shows a plugged plug-in connection from the electrical plug-in angle connector according to FIG. 10 and a corresponding mating plug-in connector, wherein a locking means of the securing element has been unlocked from the mating plug-in connector housing in order to release the securing element for a movement into the securing position, and

FIG. 12 shows the plugged plug-in connector according to FIG. 11, wherein the securing element has been moved, starting from the release position, into a securing position, in which the housing latch is secured by the securing element.

### DETAILED DESCRIPTION

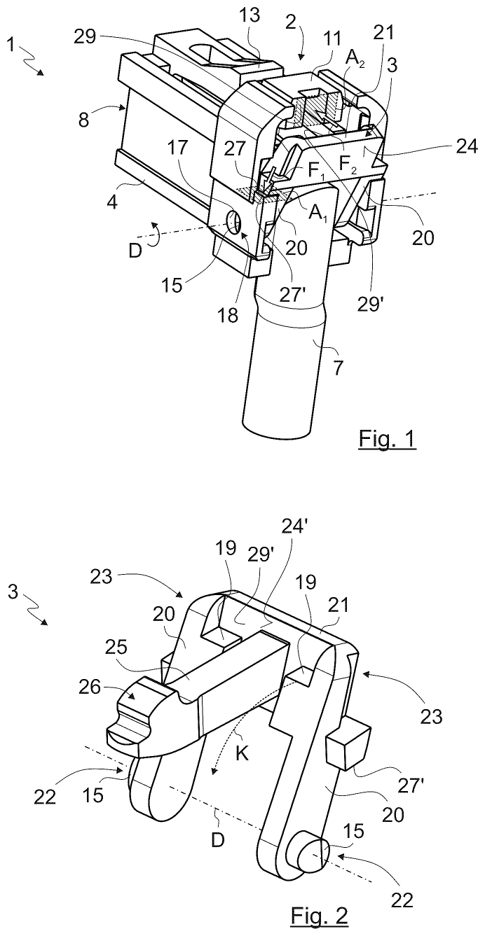

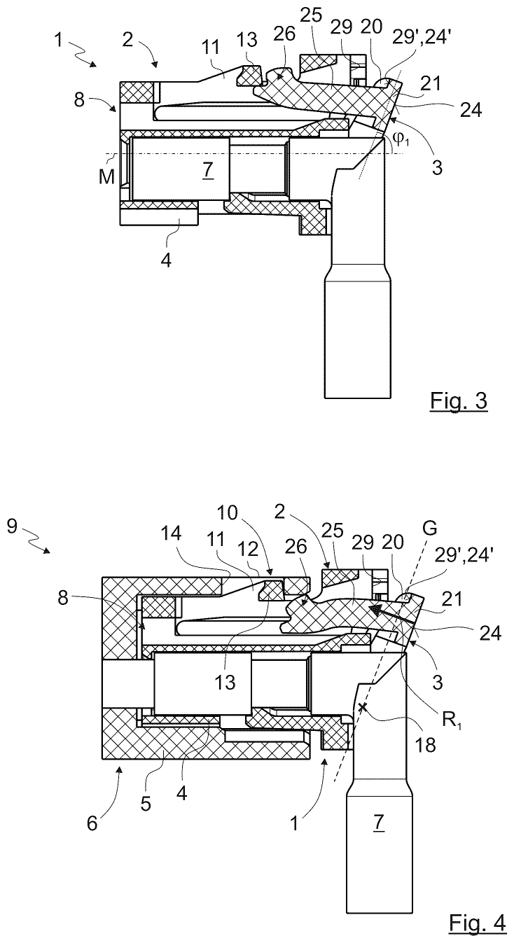

FIGS. 1 to 7 show a first exemplary embodiment of the invention. FIG. 1 shows an electrical plug-in connector 1, which, in the exemplary embodiment, is an electrical plug-in angle connector (which is not to be understood as limiting, however), with a plug-in connector housing arrangement 2 having a securing element 3. The securing element 3 is shown in a perspective individual illustration in FIG. 2. In the following text, a plug-in operation of the plug-in connector housing 4 of the plug-in connector 1 with a corresponding mating plug-in connector housing 5 of a mating plug-in connector 6 will be described with reference to FIGS. 3 to 7.

The electrical plug-in connector 1 has, by way of example, an electrical contact element 7, which is received and fixed in the plug-in connector housing 4 of the plug-in connector housing arrangement 2 (see, in particular, FIGS. 1 and 3). The plug-in connector housing 4 also has a connection interface 8 (“interface”) for connection to a corresponding mating interface of the mating plug-in connector 6 or the mating plug-in connector housing 5 (cf. FIG. 4).

The plug-in connection 9 comprising the plug-in connector 1 and the corresponding mating plug-in connector 6 or the plugged state of the plug-in connector housing 4 and the mating plug-in connector housing 5 is shown in FIGS. 4 to 7. In this plugged state, the mechanical connection between the plug-in connector 1 and the mating plug-in connector 6 is latched via a mutual housing latch 10.

The housing latch 10 is formed in the exemplary embodiments, by way of example, via a latching means 11 connected in one piece to the plug-in connector housing 4 and a corresponding mating latching means 12 of the mating plug-in connector 6, wherein the latching means of the plug-in connector housing is formed by way of example as an elastic latching rocker 11, which can enter into a latching connection with a preferably rigid mating latching means 12 of the mating plug-in connector 6. In the exemplary embodiment of FIGS. 1 to 7, for this purpose, a latching projection 13 of the locking rocker 11 of the plug-in connector housing 4 engages into a corresponding latching recess 14 in a rigid mating latching means 12 of the mating plug-in connector 6. Basically, however, the housing latch 10 can be formed in almost any desired manner, which is why the variants shown in the exemplary embodiments are to be understood merely as examples.

For the mechanical securing of the housing latch 10, the plug-in connector housing arrangement 2 or the plug-in connector 1 comprises said securing element 3, the features and operation of which is to be explained below.

In the exemplary embodiments, the securing element 3 has in each case two connecting means 15 for the exclusively rotatable and direct connection to the plug-in connector housing 4. In the connecting means shown in the first exemplary embodiment of FIGS. 1 to 7, this is by way of example a pin 15. The connecting means or the pins 15 form, together with a mating connecting means, (in the exemplary embodiment of FIGS. 1 to 7, a bore 17 in the plug-in connector housing 4) a rotary joint 18, which has a rotational axis D for said rotatable connection (see, in particular, FIG. 1). The connecting means or the pins 15 of the securing element 3 are aligned with each other here in such a way that a common rotational axis D is formed.

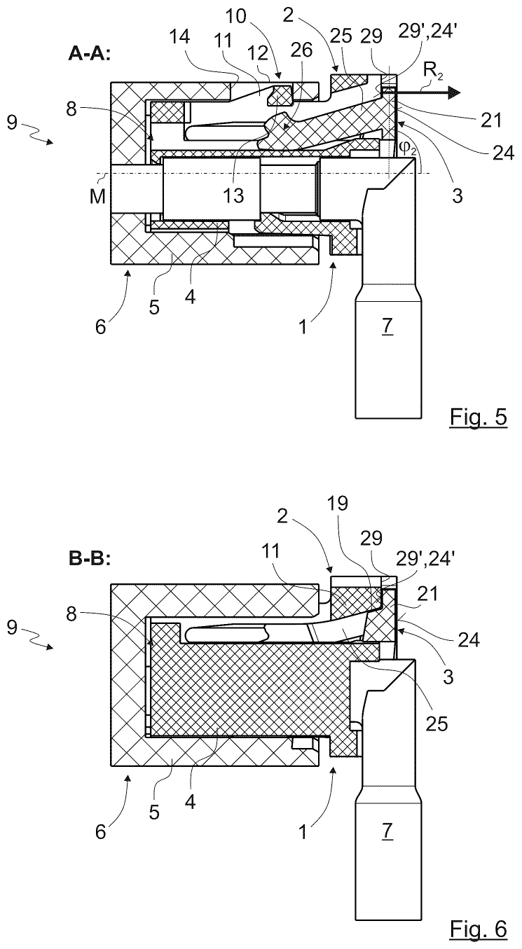

The securing element 3 also has two securing means 19, which are each connected to the connecting means or to the pins 15. Said securing means 19 are spaced apart from the rotational axis D, such that the respective securing means 19, during a rotation of the securing element 3 around the rotational axis D along a circular path K (cf. FIG. 2), can be moved, starting from a release position (shown in FIG. 3), into a securing position (shown in FIGS. 5 to 7), wherein the securing means 19 are each capable of securing the housing latch 10 of the plug-in connection 9 in the securing position. In the exemplary embodiment of FIGS. 1 to 7, the securing means is formed as a support shoulder 19, the function of which is explained below.

In the exemplary embodiments, the securing element 3 has in each case two connecting legs 20 which lie opposite each other and are connected to each other via a common connecting web 21. Each of the connecting legs 20 connects one of the connecting means or pins 15 to one of the securing means or support shoulders 19. By way of example, the connecting means or pins 15 are formed on a first end portion 22 of the connecting leg 20, and the securing means or the support shoulder 19 is formed on an opposite, second end portion 23 of the connecting leg 20.

At this point it should be mentioned that, in principle, only a single connecting leg 20 or else more than two connecting legs 20 can also be provided (or another alternative for the connection of connecting means 15 and securing means 19 to each other), which is why the embodiments above and below are not to be understood restrictively.

The securing element 3 additionally has an actuating means, which is preferably a first actuating surface 24 spaced apart from the rotational axis D, by means of which a user or a mounting device can initiate the rotation of the securing element 3 around the rotational axis D, in order to move the securing means 19 along the circular path K between the release position and the securing position. The first actuating surface 24 is arranged on that side of the connecting web 21 which faces away from the securing means 19 (see, in particular, FIG. 1 or FIG. 3). The securing element 3 can preferably also have a second actuating surface 24′ (see, in particular, FIG. 2 and FIG. 5), by means of which the user can effect the rotation of the securing element 3, starting from the securing position, back into the release position (e.g. by inserting a tool into a slot arising between the plug-in connector housing 4 and the actuating surface 24′).

In the exemplary embodiments, the securing element 3 is shown by way of example as a one-piece or one-part component, which is not necessarily required, however. In principle, the individual components or means of the securing element 3 can also be components of a multi-part securing element 3.

In FIG. 3, the securing element 3 is or the securing means 19 are initially still located in a release position, in which the movement or actuation of the housing latch 10 is possible. It can be provided, as shown in FIG. 3, that the securing element 3 has at least one elastic connecting arm 25, which is connected to the connecting means 15 (in the exemplary embodiments via the connecting web 21 of the connecting legs 20) and which is also spaced apart from the rotational axis D. Said connecting arm 25 has, on its front, free end portion, a locking means 26 which is formed to block a rotation of the securing element 3 by interacting with the plug-in connector housing 4 when the securing element 3 is located in the release position and the plug-in connector housing 4 is not yet plugged together with the mating plug-in connector housing 5. To this end, the locking means 26 comes into contact directly with the latching rocker 11 of the plug-in connector housing 4. The position shown in FIG. 3 can therefore also be referred to as “pre-latching position”. It should be mentioned here that a latch between the securing element 3 and the plug-in connector housing 4 in the release position can in principle be realized in any desired way and is also to be regarded as merely optional anyway.

In addition, the securing element 3 is also secured in the release position in the exemplary embodiments at the opposite end of the locking means 26 in the plug-in connector housing 4. For this purpose, the plug-in connector housing 4 has a first stop 27, against which a corresponding first portion 27′ of the securing element 3 bears. The first portion 27′ of the securing element 3 is formed in the exemplary embodiment of FIGS. 1 to 7 by way of example as a support web.

As arises in respect of FIG. 4, the locking means 26 of the securing element 3 can be released by the plug-in operation with the mating plug-in connector 6 by the locking means 26 being pushed out of the pre-latched position due to a corresponding elastic deformation of the locking arm 25 by the corresponding portion of the mating plug-in connector housing 5. Starting from this, a movement of the securing element 3 or its securing means 19 into the securing position is finally possible by actuation of the first actuating means or the first actuating surface 24.

The actuating direction R₁ for the first actuating means 24 is preferably not directed onto the connecting means 15 or is oriented at least substantially orthogonally with respect to a straight line G, which runs between the first actuating means 24 and the connecting means 15 or the rotary joint 18 (cf. FIG. 4). The actuating direction R₁ thus preferably runs at least substantially in the tangential direction with respect to the circular path K, along which the securing means 19 passes during the movement into the release position. Accordingly, a second actuating direction R₂ directed counter to the first actuating direction R₁ can be provided for the second actuating means or for the second actuating surface 24′, which is also preferably oriented at least substantially orthogonally with respect to the straight line G or is oriented tangentially with respect to the circular path (cf. FIG. 5).

The securing position of the securing element 3 or the securing means 19 is shown in each case in FIGS. 5 to 7. As can be seen particularly clearly with reference to FIG. 5, the locking arm 25 in the securing position of the securing element 3 is preferably again located in a mechanically relaxed state. In this state, the actuating surface 24 is preferably pivoted fully into the plug-in connector housing 4 and therefore cannot be accidentally damaged or actuated during operation of the plug-in connector 1.

The securing means 19 of the securing element 3, or the securing element 3, is thus not directly mechanically connected to the mating plug-in connector housing 5 for securing the plug-in connection 9, but rather secures the housing latch 10 or the latching means 11 or the latching rocker 11 of the plug-in connector housing 4.

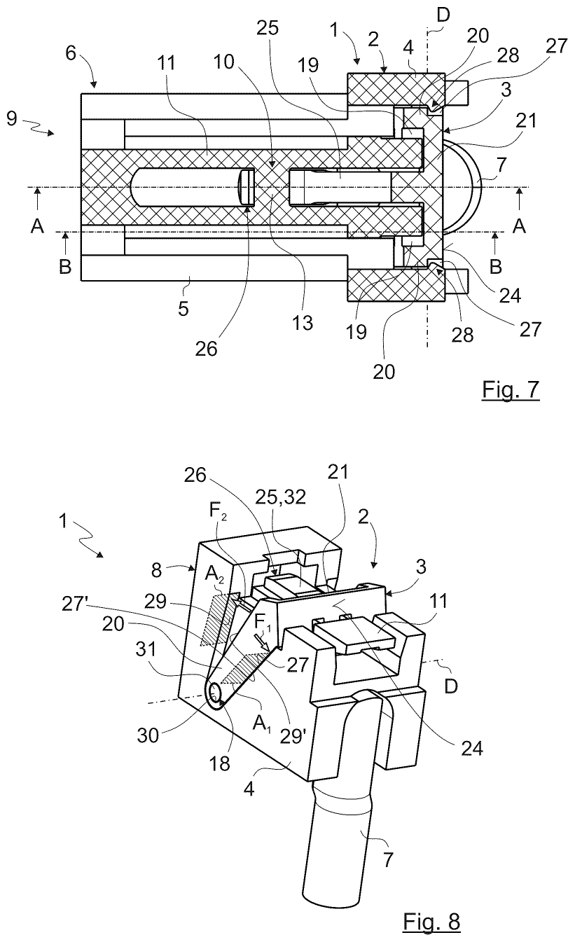

In the securing position, the securing means 19 or the support shoulders 19 block the latching rocker 11. It is therefore no longer possible to actuate the latching rocker 11 in order to unlock the mating latching means 12. The latch between plug-in connector housing 4 and mating plug-in connector housing 5 can therefore only be unlocked again when the securing element 3 is deliberately moved back into the release position by the installer, which can be possible, for example, using a corresponding tool and/or effort. The blockage of the latching rocker 11 can be seen particularly clearly by means of FIG. 6, which shows a section along the sectional plane B-B shown in FIG. 7.

It can be provided that the securing element 3 and the plug-in connector housing 4 form a mutual latching connection 28 in the securing position of the securing element 3. By way of example, for this purpose, corresponding latching hooks of the plug-in connector housing 4 are shown in FIG. 7, which are capable of engaging behind a latching recess of the securing element 3 or its connecting leg 20. The securing element 3 can thus be held securely in the securing position.

The mutual latching connection 28 in the securing position can optionally also be provided, however, in the region of the locking means 26, for example by the securing element 3 engaging behind the latching rocker 11 of the plug-in connector housing 4 with the locking means 26. In this case, however, the securing element 3 would possibly have to be extended again in the longitudinal axial direction of the plug-in connector 1, which is why a latching connection 28 shown in FIG. 7 may generally be preferred.

In addition, a second stop 29 in the plug-in connector housing 4 and a second portion 29′ of the securing element 3 which is adjacent to the second stop 29 can also be provided in the actuating direction R₁, in order to likewise provide an end stop when the securing position is reached.

The first stop 27 interacts in such a way with a first portion 27′ of the securing element 3 which bears against the first stop 27 that the securing element 3 is located in the release position in a first angular position φ₁, e.g. with respect to a center axis M of the plug-in connector 1 (cf. FIG. 3). Furthermore, the second stop 29 interacts in such a way with a second portion 29′ of the securing element 3 which bears against the second stop 29 that the securing element 3 is located in the securing position in a second angular position φ₂ different than the first angular position φ₁ (cf. FIG. 5).

The first stop 27 and the first portion 27′ of the securing element 3 which bears against the first stop 27 optionally define a first stop plane A₁ which is oriented at an angle with respect to a second stop plane A₂, which is defined by the second stop 29 and a second portion 29′ of the securing element 3 which bears against the second stop 29 (cf. FIG. 1). A first reaction force F₁, which would act on the securing element 3 during a further movement in the direction of the first stop 27, is oriented here at an angle with respect to a corresponding second reaction force F₂ on the second stop 29, wherein the orientation angle between the reaction forces is between 0° and 180°, preferably at least substantially 90°, as can be seen in FIG. 1. The reaction forces F_{1,2} are preferably defined as surface vectors or normal vectors of the respective stop planes A_{1,2}.

As an alternative to the variants of the stops 27, 29 shown in the exemplary embodiment, it can in principle also be provided that the first stop 27 and/or the second stop 29 are/is formed in the rotary joint 18 or directly adjacently with respect to the rotary joint 18.

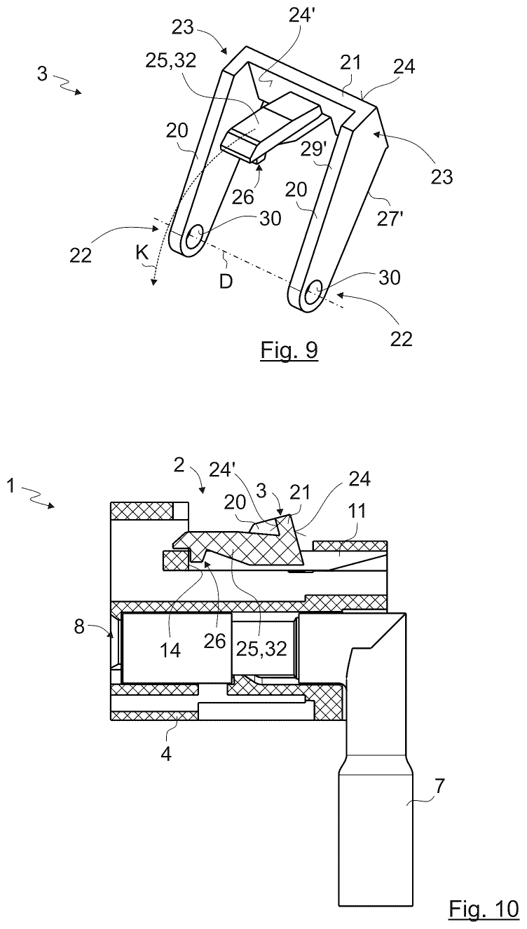

With reference to FIGS. 8 to 12, a second exemplary embodiment of the invention is now to be explained by way of example. Similar to the first exemplary embodiment, a plug-in angle connector is provided, the plug-in connector housing 4 of which has a latching rocker 11 for the formation of the housing latch 10 with a corresponding mating plug-in connector housing 5. Here, a latching projection 13 of the mating plug-in connector 6 engages into a corresponding latching recess 14 of the plug-in rocker 11 (by way of example in a complementary manner with respect to the housing latch 10 of the first exemplary embodiment). In the second exemplary embodiment, the latching projection 13 of the mating plug-in connector 6 is rigid for this purpose and the latching rocker 11 of the plug-in connector 1 is formed flexibly, such that the latching rocker 11 is temporarily raised during the plug-in operation by the latching projection 13 of the mating plug-in connector 6. In contrast, in the first exemplary embodiment, the elastic latching projection 13 of the plug-in connector housing 4 was deflected by the mating latching means 12 of the mating plug-in connector housing 5. It is thus to be demonstrated that a latching projection 13 within the context of the invention can be either rigid or elastic and also optionally formed by the plug-in connector housing 4 or the mating plug-in connector housing 5.

For simplification, substantially the differences between the exemplary embodiments will be discussed in the following.

In contrast to the first exemplary embodiment, it is clarified with reference to the second exemplary embodiment that the connecting means 15 (singular) and the connecting means 15 (plural) of the securing element 3 does/do not necessarily have to be formed as a pin. By way of example, the connecting means 15 in the exemplary embodiment shown in FIGS. 8 to 12 are formed as bores 30 for receiving a pin 31 of the plug-in connector housing 4.

Once again, two connecting legs 20 are provided, which are connected to each other via a common connecting web 21, wherein the connecting means 15 in turn are arranged together with the plug-in connector housing 4 on the first end portion 22 of the connecting legs 20 in order to form the rotary joint 18. In contrast to the previous exemplary embodiment, the securing element 3 in FIGS. 8 to 12, however, has only a single securing means, which additionally is also not formed on the second end portion 23 of the connecting leg 20, but rather as an elevation 32, which, starting from the connecting web 21, extends at least substantially in the plug-in direction or in the actuating direction R₁ or in the tangential direction of the circular path K, along which the securing element 3 is movable. Accordingly, the securing means or the elevation 32 in FIGS. 8 to 12 also has the locking arm 25.

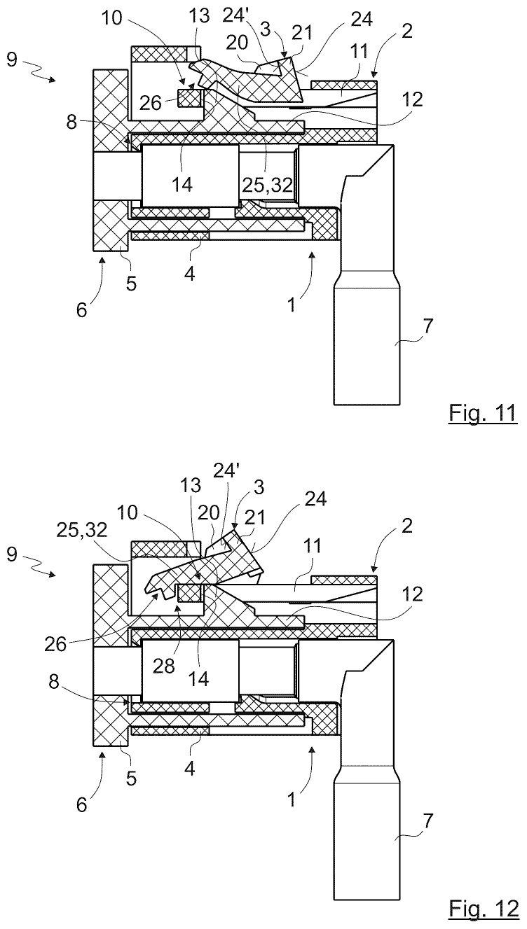

The plug-in operation of the plug-in connector housing 4 with the corresponding mating plug-in connector housing 5 and thus the movement of the securing means 32 from the release position into the securing position can be clearly seen by means of FIGS. 10 to 12. In FIG. 10, the securing means 32 is located in the release position, wherein the securing element 3 is pre-latched in this position using the locking means 26, such that a movement of the securing element 3 into the securing position is only possible by mechanically influencing the connecting arm 25 by plugging in the mating plug-in connector housing 5 (cf. the raised state of the locking means 26 shown in FIG. 11).

The securing position of the securing means 32 is finally also shown in FIG. 12, wherein the mutual latching connection 28 between the securing element 3 and plug-in connector housing 4 in the securing position is ensured in this case by the locking means 26 engaging behind the latching means 11. As shown in FIG. 12, the locking means 26 or the securing means 32 for this purpose engages behind the latching rocker 11.

1. A securing element, for mechanically securing a housing latch of a plug-in connection, the securing element comprising:
at least one connecting means for an exclusively rotatable-and-direct connection to a plug-in connector housing of a plug-in connector of the plug-in connection, which, together with a mating connecting means of the plug-in connector housing, forms a rotary joint having a rotational axis (D); and
at least one securing means connected to the at least one connecting means, the at least one securing means being spaced apart from the rotational axis (D), such that during a rotation of the securing element around the rotational axis (D) along a circular path (K), the at least one securing means is moveable from a release position into a securing position in which the at least one securing means secures the housing latch of the plug-in connection.

2. The securing element of claim 1, further comprising at least one connecting leg connecting the at least one connecting means to the at least one securing means;
wherein the connecting means is formed on a first end portion of the at least one connecting leg; and
wherein the securing means is formed on one of: (a) a second end portion of the at least one connecting leg that is opposite of the first end portion of the at least one connecting leg, (b) a connecting web, or (c) an elevation connected to either the connecting leg or the connecting web.

3. The securing element of claim 1, wherein the at least one connecting means includes (a) a bore configured to receive a pin of the plug-in connector housing, or (b) a pin configured to be received in a bore of the plug-in connector housing.

4. The securing element of claim 1, further comprising an actuator configured to enable an initiation of the rotation of the securing element about the rotational axis (D) in order to move the at least one securing means along the circular path (K) between the release position and the securing position.

5. The securing element of claim 4, wherein an actuating direction for the actuator is oriented at least substantially orthogonally with respect to a straight line (G) running between the actuator and the at least one connecting means.

6. The securing element of claim 1,
wherein the securing element further comprises a locking member connected to the at least one connecting means and spaced apart from the rotational axis (D), and
wherein the locking member is configured (a) to block a rotation of the securing element by an interaction with the plug-in connector housing, when the at least one securing means is located in the release position, and (b) to release the securing element as a result of the plug-in operation with the mating plug-in connector.

7. A plug-in connector housing arrangement for a plug-in connector, the plug-in connector housing arrangement comprising:
a plug-in connector housing; and
a securing element;
wherein the securing element includes at least one connecting means and at least one securing means connected to the at least one securing means;
wherein the at least one connecting means, together with a mating connecting means of the plug-in connector housing, forms a rotary joint having a rotational axis (D) and being exclusively connected rotatably and directly to the plug-in connector housing; and
wherein the at least one securing means is spaced apart from the rotational axis (D), such that during a rotation of the securing element around the rotational axis (D) along a circular path (K), the at least one securing means is moveable from a release position into a securing position in which the at least one securing means secures a housing latch.

8. The plug-in connector housing arrangement of claim 7, wherein the housing latch is formed by (a) a latching means, which is connected in one piece to the plug-in connector housing, and (b) a corresponding mating latching means of the mating plug-in connector.

9. The plug-in connector housing arrangement of claim 8, wherein the latching means is designed as an elastic latching hook or as an elastic latching rocker.

10. The plug-in connector housing arrangement of claim 7,
wherein, in the release position of the securing means, the securing element bears against a first stop of the plug-in connector housing; and
wherein, in the securing position of the securing means, the securing element bears against a second stop of the plug-in connector housing.

11. The plug-in connector housing arrangement of claim 10,
wherein, in the release position, a first portion of the securing element bears against the first stop, such that the securing element is oriented in a first angular position (φ₁), and
wherein, in the securing position, a second portion of the securing element bears against the second stop, such that the securing element is oriented in a second angular position (φ₂) different than the first angular position (φ₁).

12. The plug-in connector housing arrangement of claim 10, wherein at least one of the first stop and the second stop is formed either in the rotary joint or adjacently to the rotary joint.

13. The plug-in connector housing arrangement in claim 7, wherein the plug-in connector housing is a plug-in angle connector housing.

14. A plug-in connection comprising:
a plug-in connector; and
a mating plug-in connector;
wherein the plug-in connector comprises a plug-in connector housing arrangement including a plug-in connector housing and a securing element;
wherein the securing element includes at least one connecting means and at least one securing means connected to the at least one connecting means;
wherein the at least one connecting means, together with a mating connecting means of the plug-in connector housing, forms a rotary joint having a rotational axis (D) and being exclusively connected rotatably and directly to the plug-in connector housing;
wherein the at least one securing means is spaced apart from the rotational axis (D), such that during a rotation of the securing element around the rotational axis (D) along a circular path (K), the at least one securing means is moveable from a release position into a securing position in which the at least one securing means secures a housing latch;
wherein the mating plug-in connector includes a mating plug-in connector housing;
wherein the plug-in connector housing is mechanically connected to the mating plug-in connector housing so as to form a connection; and
wherein said connection is (a) latched via the housing latch, and (b) is secured via the securing element securing the housing latch.

15. The plug-in connection of claim 14, wherein the securing means of the securing element is mechanically connected to the mating plug-in connector housing indirectly.

16. The plug-in connection of claim 15, wherein the entire securing element is mechanically connected to the mating plug-in connector housing indirectly.

17. The plug-in connection of claim 14,
wherein the securing element further comprises at least one connecting leg connecting the at least one connecting means to the at least one securing means;
wherein the connecting means is formed on a first end portion of the at least one connecting leg; and
wherein the securing means is formed on one of: (a) a second end portion of the at least one connecting leg that is opposite of the first end portion of the at least one connecting leg, (b) a connecting web, or (c) an elevation connected to either (i) the connecting leg or (ii) the connecting web.

18. The plug-in connection of claim 17, wherein the at least one connecting means includes (a) a bore configured to receive a pin of the plug-in connector housing, or (b) a pin configured to be received in a bore of the plug-in connector housing.

19. The securing element of claim 2, wherein the at least one connecting leg comprises two connecting legs that lie opposite each other and that are connected to each other via the connecting web.

20. The securing element of claim 4, wherein the at least one actuating means includes an actuating surface that is spaced apart from the rotational axis.
